(19) United States
(12) Patent Application Publication
(10) Pub. No.: US 2013/0335631 A1
(43) Pub. Date: Dec. 19, 2013

(54) VIDEO DEVICE AND METHOD FOR STARTING APPLICATION

(71) Applicant: HON HAI PRECISION INDUSTRY CO., LTD., New Taipei (TW)

(72) Inventor: HONG-SHENG CHEN, New Taipei (TW)

(73) Assignee: HON HAI PRECISION INDUSTRY CO., LTD., New Taipei (TW)

(21) Appl. No.: 13/778,152

(22) Filed: Feb. 27, 2013

(30) Foreign Application Priority Data
Jun. 13, 2012 (TW) 101121048

(51) Int. Cl. H04N 5/445

(52) U.S. Cl. CPC H04N 5/44543
USPC 348/570

(57) ABSTRACT

An application starting method is applied to a video device. The video device can display television programs and perform other functions and applications. The application starting method includes providing a channel table, the channel table listing television channel numbers, and collections of information, each relating to a particular television channel, a plurality of application channel numbers, and a plurality of icons for the applications. By selecting channel numbers a user can start an application.

### BACKGROUND

1. Technical Field

The present disclosure relates to video devices, more particular to a video device capable of receiving television signals and a method for starting applications of the video device.

2. Description of Related Art

Video devices such as a television, a set top box (STB),or some smart phones can play and display television signals. The video devices also have a plurality of applications installed for providing special functions other than receiving and displaying television signals. For example, the special functions may be a calendar function, a computing function, a game-playing function, and the like. In operation, uses may operate a remote video device to display a main menu containing icons for these applications, and then operate the remote video device to select one of the icons to activate the corresponding application. However, the operation steps to select and activate the applications are often cumbersome and tedious for users.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of function modules of a video device in accordance with a first embodiment.

FIGS. 2 and 3 are sketch maps of a graphical user interface provided by the video device of FIG. 1.

FIG. 4 is a flow chart of an application starting method in accordance with an embodiment.

FIG. 5 is a flow chart of a method for generating a channel number for an application in accordance with a first embodiment.

FIG. 6 is block diagram of function modules of a video device in accordance with a second embodiment.

FIGS. 7 and 8 are sketch maps of a graphical user interface provided by the video device of FIG. 6.

FIG. 9 is a flow chart of a method for generating a channel number for an application in accordance with a second embodiment.

### DETAILED DESCRIPTION

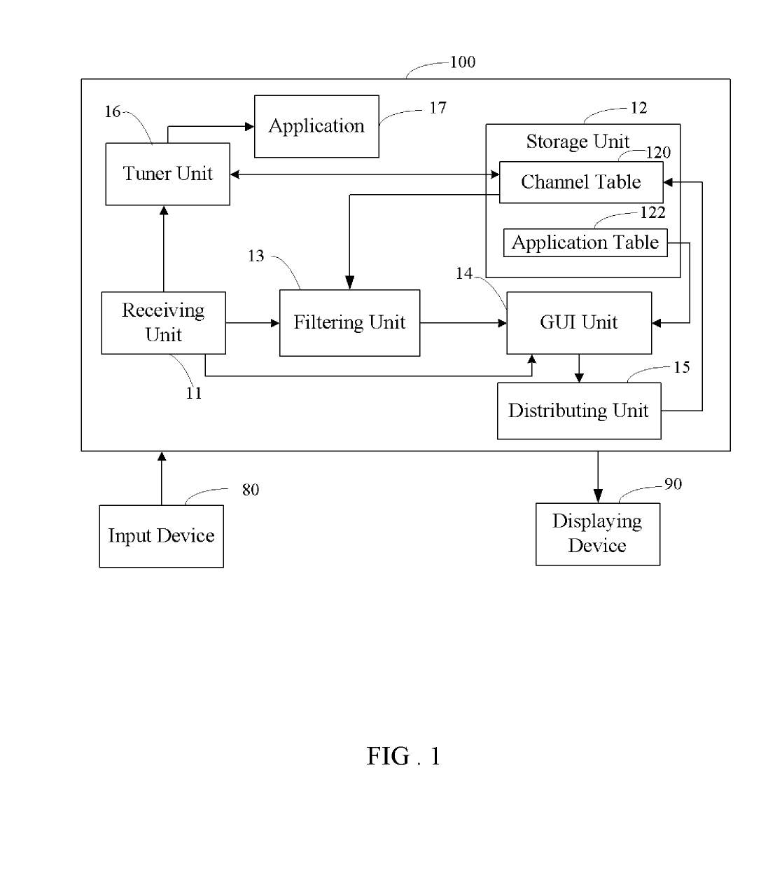

Referring to FIG. 1, a video device 100 in accordance with a first embodiment is shown. The video device 100 is manipulated by an input device 80, and is capable of playing and displaying information via a displaying device 90. The video device 100 may be a video device capable of displaying television program, such as a television, an STB, or a media player. In this embodiment, the input device 80 is a remote control device. In another embodiment, the input device 80 may be a keyboard or a keypad set in the video device 100. The displaying device 100 may be an LCD display, an LED display, or a PDP display. In this embodiment, the video device 100, the input device 80, and the displaying device 90 are devices independent of each other. In another embodiment, the video device 100, the input device 80, and the displaying device 90 are integral.

The video device 100 includes a receiving unit 11, a storage unit 12, a filtering unit 13 and a graphical user interface (GUI) unit 14, a distributing unit 15, a tuner unit 16, and a plurality of applications 17. Each application 17 performs a special function, such as showing a calendar, computing function, game playing function, or video displaying function.

The receiving unit 11 receives user commands inputted via the input device 80. In this embodiment, user commands may be a setting command, a channel select command or other commands. For example, the user can press a predetermined button to generate the setting command. The user can press the channel+ or channel− keys or number keys to generate the channel select commands. The channel select commands may be the selection of a channel number.

The storage unit 12 stores a channel table 120 and an application table 122. The channel table 120 lists a plurality of channel numbers. In this embodiment, the channel table 120 further lists a plurality of groups of television channel numbers and other channel information after the video device 100 performs channel searching. One collection of information associates to one channel number. The channel numbers associating with the collection of information are called television channel numbers. In this embodiment, a sum of the channel numbers is larger than a sum of the television channel numbers, thus there are channel numbers which are not associated with any information and the channel numbers without association are called idle channel numbers. The application table 120 lists a plurality of icons associating with the applications 17.

The filtering unit 13 filters out the television channel numbers from the storage unit 12 to obtain idle, unassociated, channel numbers in response to the setting commands input by the user.

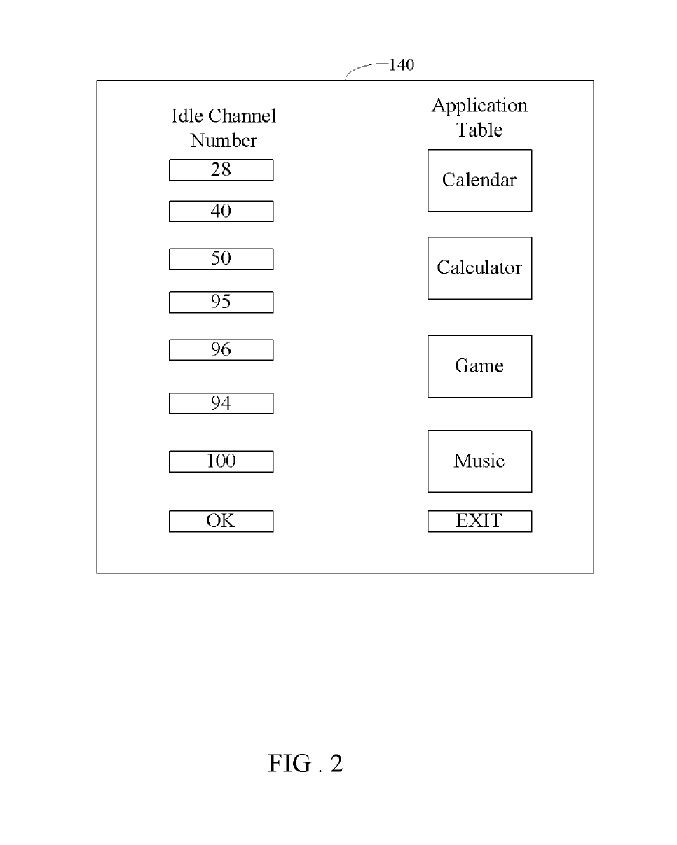

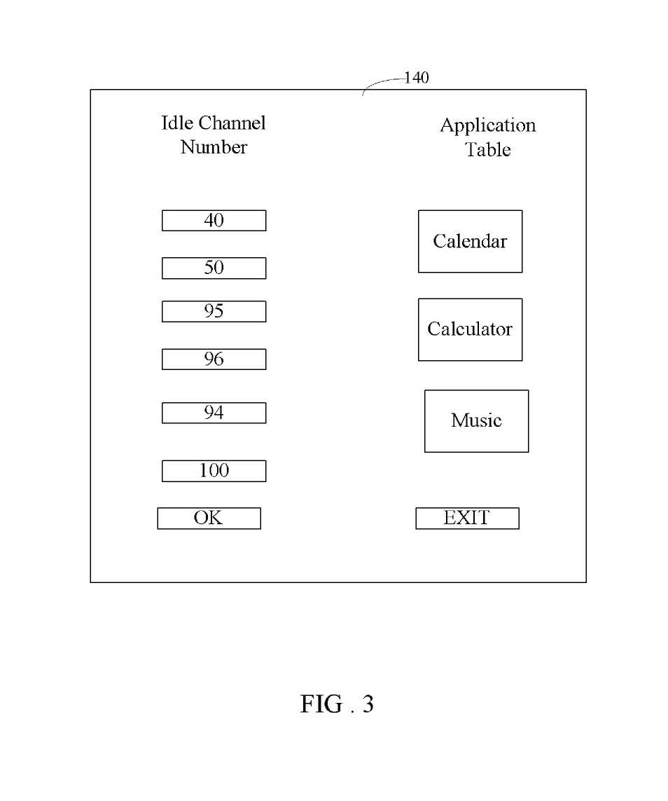

Referring to FIGS. 2 and 3, the GUI unit 14 displays a GUI 140 containing the idle channel numbers and the icons associating with the applications 17 on the displaying device 90. One idle channel number and one icon are selected at one time by the user. The GUI unit 14 is further configured to delete the selected icon and the selected idle number and generate a distributing signal.

The distributing unit 15 records the selected icon in the channel table 120 and associates the selected idle number with the selected icon, such that the selected idle number is always associated with the application corresponding to a selected icon. The channel numbers associated with the icons are called application channel numbers.

The tuner unit 16 searches the storage unit 12 to determine whether a channel number input by the user is a television channel number or an application channel number based on the information associating with the input channel number, in response to the channel select command. When the tuner unit 16 finds that the inputted channel number is associated with the television information, the tuner unit 16 tunes into a television channel corresponding to the inputted channel number, and the video device 100 plays television programs from the television channel. When the tuner unit 16 finds that the input channel number is associated with an icon, the tuner unit 16 generates an instruction to start the application 17 associated with the icon which corresponds to the inputted channel number.

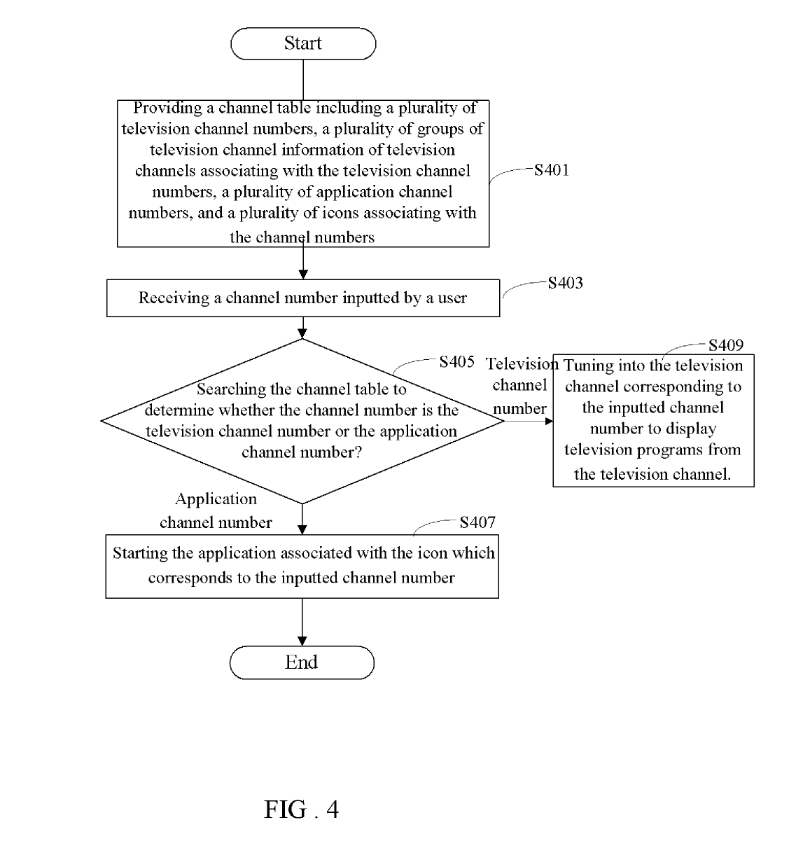

Referring to FIG. 4, an application starting method is applied to the video device 100. The application starting method includes the following steps:

In step S401, providing a channel table, the channel table includes a plurality of television channel numbers, a plurality of collections of information of television channels associating with the television channel numbers, a plurality of application channel numbers, and a plurality of icons associating with the channel numbers. One collection of television information associates to one television channel number. One icon associates to one application channel.

In step S403, the receiving unit 11 receives a channel number inputted by a user.

In step S405, the channel table is searched to determine whether the channel number is a television channel number or an application channel number. When the input channel number is an application channel number, the process goes to step S407. When the input channel number is a television channel, the process goes to step S409.

In step S407, the application associated with the icon which corresponding to the input channel number is started.

In step S409, the tuner unit 16 tunes into the television channel corresponding to the input channel number to play and/or display television programs from the television channel.

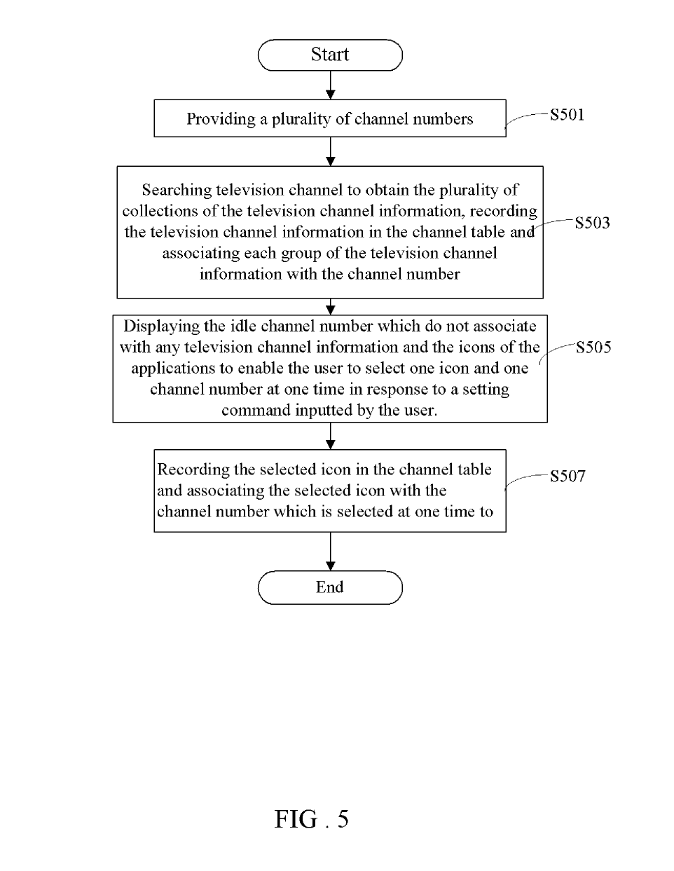

Referring to FIG. 5, in the application starting method, the channel table is generated by the following steps:

In step S501, providing a plurality of channel numbers when the video device is manufactured.

In step S503, searching through television channels to obtain a plurality of collections of television channel information, recording the television channel information in the channel table and associating each collection of information with the channel number.

In step S505, displaying the idle channel number which are not associated with any television channel information and the icons of the applications to enable the user to select one icon and one channel number at one time in response to a user setting command

In step S507, recording the selected icon in the channel table and associating the selected icon with a channel number which may be selected at one time, to determine the channel numbers respectively associating with the icons, to be the application channel numbers.

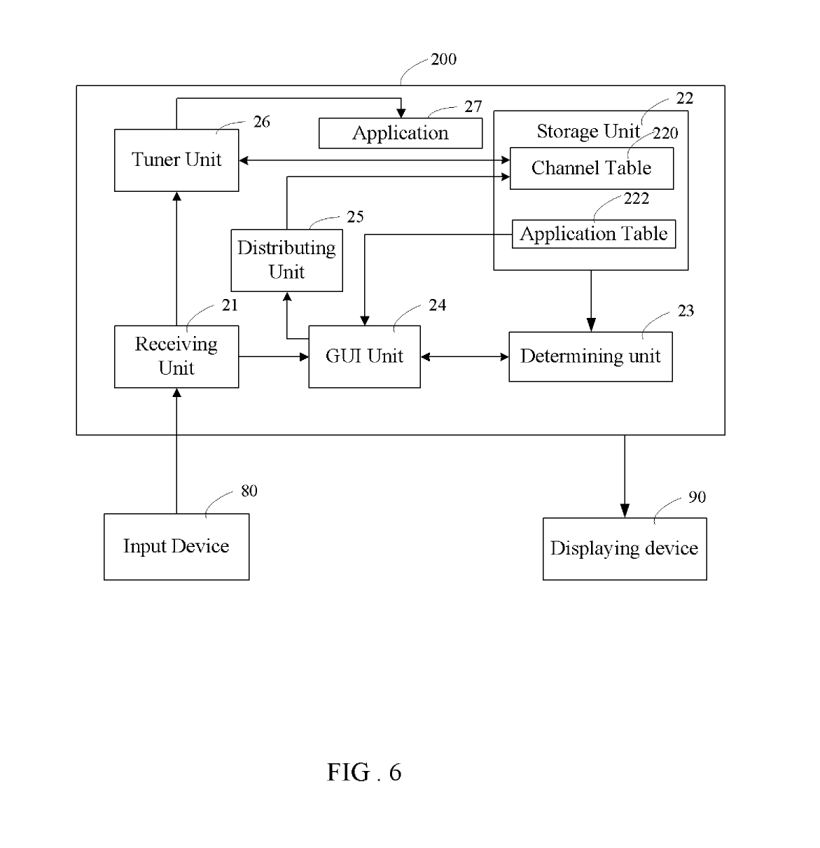

Referring to FIG. 6, a video device 200 in accordance with a second embodiment is shown. The video device 200 is manipulated by an input device 80, and plays and displays information on a displaying device 90. The video device 200 includes a receiving unit 21, a storage unit 22, a determining unit 23, and a graphical user interface (GUI) unit 24, a distributing unit 25, a tuner unit 26, and a plurality of applications 27.

The receiving unit 21 receives user commands inputted through the input device 80. In this embodiment, user commands may be a setting command, a channel select command or other commands. For example, the user can press a predetermined button set on the input device 80 to generate the setting command. The user can press the channel+ or the channel− keys or the number keys to generate the channel select command The channel select command indicates the channel number.

The storage unit 22 stores a channel table 220 and an application table 222. The channel table 220 lists a plurality of channel numbers. In this embodiment, the channel table 220 further lists a plurality of collections of information, each collection of information relating to individual television channels, after the video device 200 has performed channel searching. One collection of information is associated with one channel number. The channel numbers associated with the television channel information are called television channel numbers. In this embodiment, a sum of the channel numbers is larger than a sum of the television channel numbers, therefore, there are some channel numbers which are not associated with any information and such unassociated channel numbers are called idle channel numbers. The application table 220 lists a plurality of icons associating with the applications 27.

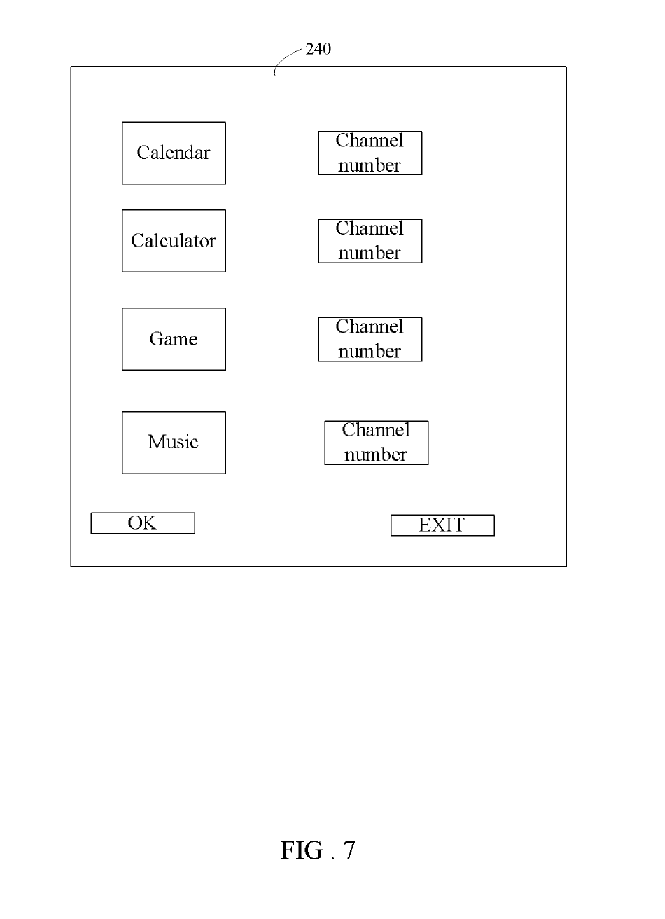

Referring to FIG. 7, the GUI unit 24 displays a GUI 240 on the displaying device 90. The GUI 240 includes icons of the applications and a plurality of dialog boxes 240 associating with the icons. Each dialog box 240 can be activated to receive a channel number inputted by the user to indicate that a particular channel number which has been inputted is to be associated and connected to the application associated with the icon corresponding to the activated dialog boxes 240, and the input channel number is sent to the determined unit 23.

The determining unit 23 determines whether the input channel number is an idle channel number. When the input channel number is idle, the determining unit 23 generates a distributing command. When the input channel number is not idle, the determining unit 23 further determines whether the idle input channel is a television signal. When the input signal channel is not a television channel, the determining unit 23 generates a warning signal. When the input signal channel is a television channel, the determining unit 23 generates an invalidation command.

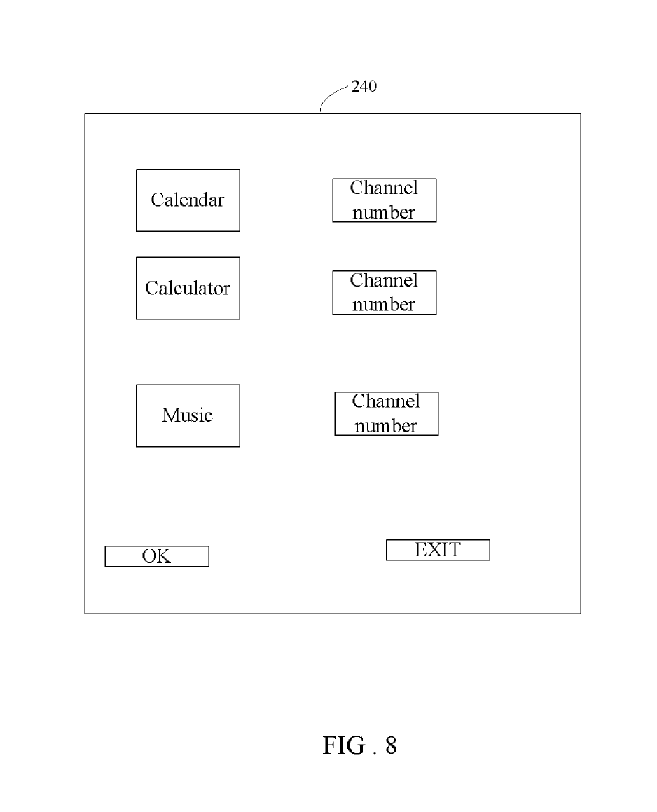

Referring to FIG. 8, the GUI unit 24 is further configured to delete the dialog box 240 and the corresponding icon in response to a distributing command. The GUI unit 24 is further configured to provide information and a button to enable the user to generate an invalidation signal by clicking.

The GUI unit 24 provides a warning to the user that the input channel number is associated with a different icon in response to the warning signal, and the GUI unit 24 is further configured to provide a button to enable the user to generate the distributing command in response to the warning signal, by clicking.

The distributing unit 25 records the icon associating with the activated dialog box 240, and associates the icon associated with the activated dialog box 240 with the input channel number in response to the distributing command. The channel numbers associated with icons are called application channel numbers.

The tuner unit 26 searches the channel table 220 to determine whether the channel number inputted by the user is a television channel number or an application channel number in response to receiving the channel select command, based on the information associated with the inputted channel number. When the tuner unit 26 finds that the inputted channel number associates with the television information, the tuner unit 26 tunes into the television channel corresponding to the inputted channel number, and the video device 200 plays television programs from the television channel. When the tuner unit 26 finds that the inputted channel number associates with an icon, the tuner unit 26 searches for the application based on the icon, and the tuner unit 26 generates an instruction to enable the video device 200 to start the application 27 associated with the icon which corresponds to the inputted channel number.

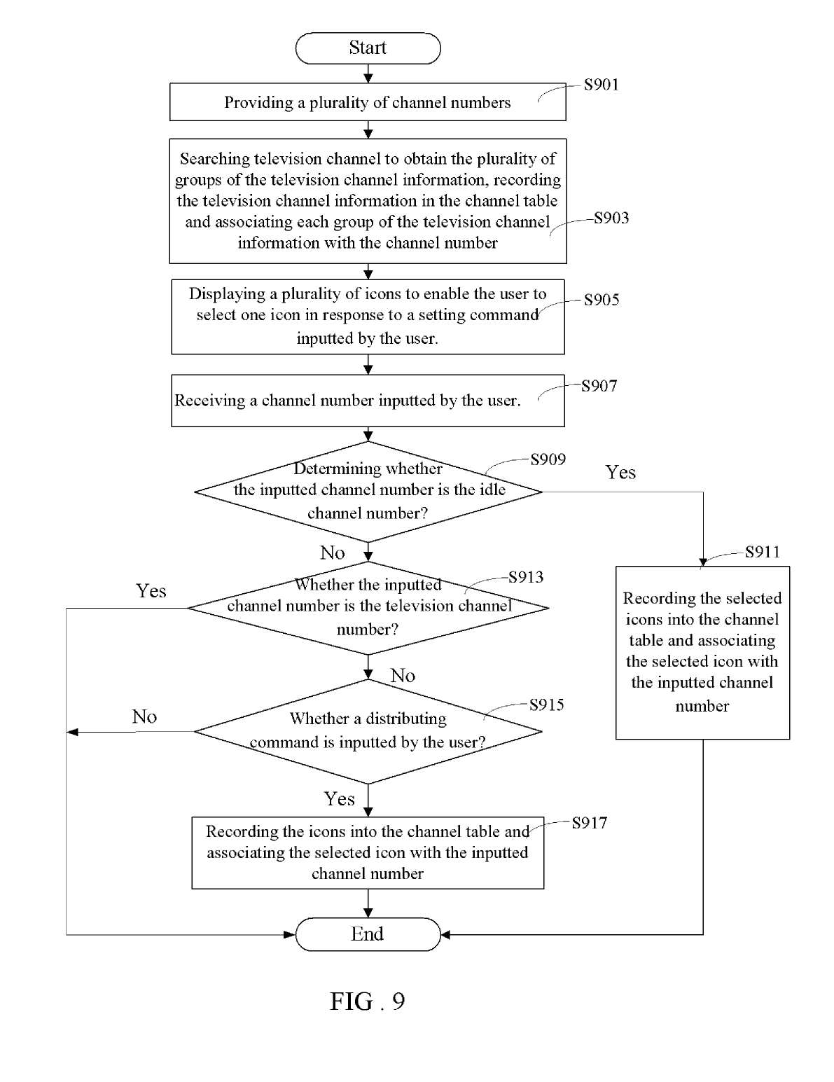

Referring to FIG. 9, the application starting method of a second embodiment, to generate the channel table, includes the following steps:

In step S901, providing a plurality of channel numbers when the video device is manufactured.

In step S903, searching television channels to obtain a plurality of collections of information relating to television channels, recording the television channel information in the channel table and associating each collection of information relating to television channels with the channel number to determine the channel numbers associating with the television channel information (the television channel numbers).

In step S905, displaying a plurality of icons to enable the user to select one icon in response to a setting command.

In step S907, receiving a channel number inputted by the user.

In step S909, determining whether the input channel number is an idle channel number. When the input channel number is an idle channel number, the process goes to step S911. When the input channel number is not an idle channel number, the process goes to step S913.

In step S911, recording the selected icons into the channel table and associating the selected icon with the input channel number.

In step S913, determining whether the input channel number is a television channel number. When the input channel number is the television channel number, the process ends. When the input channel number is not the television channel number, the process goes to step S915.

In step S915, determining whether a distributing command is inputted by the user. When a distributing command is inputted by the user, the process goes to step S917. When a distributing command is not input by the user, the process ends.

In step S917, recording the icons into the channel table and associating each selected icon with the input channel number.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A video device capable of displaying television programs, the video device comprising:
a plurality of applications, each application having an icon, the icon can be activated to start the corresponding application;
a storage unit to store a channel table, the channel table listing a plurality of television channel numbers, a plurality of groups of television information, a plurality of application channel numbers, and the icons of the plurality of application; one group of the television information associating with one television channel number, one application channel number associating with one icon; and
a tuner unit to search the channel table in response to a channel number inputted by the user, when one television channel number is activated by the inputted channel number, the tuner unit can tune to a television channel corresponding to the inputted channel number to enable a television program from the corresponding television channel to be displayed; when one application channel number is activated by the inputted channel number, the tuner unit generating an instruction to start the application associated with the icon which corresponds to the inputted channel number.

2. The video device of claim 1, wherein the plurality of the groups of the television information exists in the channel table after a television searching is performed, the television channel numbers associate with the groups of the television information.

3. The video device of claim 1, wherein the video device further comprises a distributing unit, the distributing unit is configured to associate one application channel number with one icon in response to distributing commands inputted by the user.

4. A video device comprising:
a storage unit to store a channel table, the channel table listing a plurality of channel numbers, and a plurality of groups of television information; the channel number includes a plurality of television channel numbers and at least one idle number; one group of television information signal associated with one television channel number;
a plurality of applications, each application associated with an icon;
a distributing unit to distribute one idle channel number to one application to form one application channel number by recording the icon of the one application into the channel table, and associating the one idle channel number with the icon of the one application in response to an distributing command input by a user; and
a tuner unit to search channel table in response to a channel number inputted by the user, when one television channel number is activated by the inputted channel number, the tuner unit can tune to the corresponding television channel to enable the video device displaying a television program from the corresponding television channel;
when application channel number is activated by the input channel number, the tuner unit generating an instruction to start the application associated with the icon which corresponds to the inputted channel number.

5. The video device of claim 4, wherein the video device further comprises a filtering unit, and a graphical user interface (GUI) unit, the filtering unit is configured to search the channel table for the idle channel numbers in response to setting commands inputted by the user, the GUI unit is configured to displaying the idle channel numbers and the icons of the plurality of applications on a display, one idle channel numbers and one icon can be selected at one time by the user to generate the distributing command, the distributing unit records the selected icon and associating the selected icon with the selected idle channel number in response to the distributing command.

6. The video device of claim 4, wherein the video device further comprises a determining unit, and a graphical user interface (GUI) unit, the GUI unit is configured to display the icons of the plurality of applications and a plurality of dialog boxes associating with the icons on a display, each dialog box can be inputted with a channel number by the user, the determining unit is configured to determine whether the input channel number is the idle channel number, when the input channel number is the idle channel number, the determining unit generates the distributing command, the distributing unit records the icon associated with the dialog box with the input channel number, and associates the recorded icon with the idle channel number which is corresponding to the inputted channel number in response to the distributing command.

7. The video device of claim 6, wherein when the input channel number is not the idle channel, the determining unit further determines whether the input channel number is the television channel number, when the input channel is the television channel, the determining unit generates an invalidating command to enable the GUI unit to provide information to inform the user the input channel number is an invalidating channel number; when the input channel is the television channel, the determining unit provides information to inform the user that the input channel number associates with one icon difference from icon associated to the dialog box with the input channel number, and the determining unit provides a button to be activated by the user to associate the input channel number with the icon associated to the dialog box with the input channel number.

8. An application starting method executed in a video device, the video device comprising a plurality of application, the application starting method comprising steps of:
providing a channel table, the channel table listing a plurality of television channel numbers, a plurality of groups of television information, a plurality of application channel numbers, and a plurality of icons associating with the applications, each television channel number associating with one group of the television information, each application channel number associating with one icon;
receiving a channel number inputted by the user;
searching the channel table to determine whether the inputted channel number is the television channel or the application channel number;
starting the application associating with the icon which associates with the input channel number when the input channel number is the application channel number.

9. The application starting method of claim 8, wherein the channel table is generated by the following steps:
providing a plurality of channel numbers;
searching television channel to obtain the plurality of groups of the television channel information, recording the television channel information in the channel table and associating each group of the television channel information with the channel number to determine the channel number associating with the television channel information as the television channel numbers;
filtering out the television channel numbers to obtain the idle channel number which is not associating with any television channel information in response to a setting command input by the user;
displaying the idle channel number and the icons of the application to enable the user to select one icon and one channel number at one time; and
recording the selected icon in the channel table and associating the selected icon with the channel number which is selected at one time to determine that the channel numbers associating with the icons as the application channel numbers.

10. The application starting method of claim 8, wherein the channel table is generated by the following steps:
providing a plurality of channel numbers;
searching television channel to obtain the plurality of groups of the television channel information, recording the television channel information in the channel table and associating each group of the television channel information with the channel number to determine the channel number associating with the television channel information as the television channel numbers;
displaying the icons of the applications;
selecting one icon;
receiving a channel number input by the user;
determining whether the inputted channel number is an idle channel number which is not associated with any information; and
recording the selected icon in the channel table and associating the selected icon with the inputted channel number to determine that the channel numbers associating with the icons as the application channel numbers when the inputted channel number is the idle channel number.

11. The application starting method of claim 10, wherein when the inputted channel number is not an idle channel number, the application starting method further comprising steps of:
determining whether the input channel number is the television channel number;
determining whether a validating signal is inputted by the user when the input channel number is not the television channel number; and
recording the selected icons into the channel table and associating the selected icon to the inputted channel number.
